(19) United States
(12) Patent Application Publication
(10) Pub. No.: US 2013/0171506 A1
(43) Pub. Date: Jul. 4, 2013

(54) ENERGY STORAGE APPARATUS

(71) Applicant: Li-Tec Battery GmbH, Kamenz (DE)

(72) Inventor: Harald Reiche, Saint-Louis (FR)

(73) Assignee: LI-TEC BATTERY GMBH, Kamenz (DE)

(21) Appl. No.: 13/733,534

(22) Filed: Jan. 3, 2013

Related U.S. Application Data
(60) Provisional application No. 61/582,500, filed on Jan. 3, 2012.

(30) Foreign Application Priority Data
Jan. 3, 2012 (DE) 10 2012 000 048.0

(51) Int. Cl. H01M 6/42; H01G 9/00; H01M 2/00

(52) U.S. Cl. CPC H01M 6/42; H01M 2/00; H01G 9/0029
USPC 429/156; 29/623.1; 29/25.03

(57) ABSTRACT

The invention relates to an energy storage apparatus and also to a method for producing an energy storage apparatus with two or a plurality of energy storage cells (14), with each storage cell comprising at least one electrode stack and/or electrode coil and two or a plurality of shell-like containers (10), each shell-like container (10) comprising one base surface (11), one shell wall (12) and an opening (13) located opposite the base surface (11), wherein one energy storage cell (14) is arranged in each of the shell-like containers (10).

To simplify the structure or the production, the shell-like containers (10) are arranged next to one another in a row or stacked one above the other such that, in particular for each pair of shell-like containers (10), a first shell-like container (10), in which an energy storage cell (14) is arranged, is inserted with its base surface (11) into a second shell-like container (10), in which an energy storage cell (14) is arranged.

This application claims the benefit of U.S. Provisional Patent Application Ser. No. 61/582,500, filed Jan. 3, 2012 and which is incorporated by reference herein in its entirety. This application also claims priority to German Patent Application No. DE 10 2012 000 048.0, filed Jan. 3, 2012 and which is incorporated by reference herein in its entirety.

The present invention relates to an energy storage apparatus and also to a method for producing such an energy storage apparatus according to the preamble of the independent claims.

Energy storage apparatuses known from the prior art have at least one electrochemical energy storage cell, which is also designated as electrochemical cell or galvanic cell, in the form of an electrode stack or electrode coil which is generally surrounded by a housing. The electrode stack for the most part has a plurality of electrode groups, each group composed of two electrodes, and also a separator layer, which may accommodate an electrolyte, located therebetween, which electrode groups are arranged or stacked next to one another or above one another. In the case of an electrode coil, at least one electrode group is wound to form a so-called coil. The electrodes of the electrode groups of the same polarity are each electrically connected to a current collector, via which the electrical voltage generated in the cell can be externally collected.

It is the object of the present invention to specify an energy storage apparatus with a structure which is as simple as possible and also a method for the simplified production of such an energy storage apparatus.

This object is achieved by means of an energy storage apparatus and a method for producing such an energy storage apparatus according to the independent claims.

The energy storage apparatus according to the invention has two or a plurality of energy storage cells, each with at least one electrode stack and/or electrode coil, and also two or a plurality of shell-like containers, each with one base surface, one shell wall and an opening located opposite the base surface, wherein one energy storage cell is arranged in each shell-like container, and said energy storage apparatus is characterized in that the shell-like containers are arranged next to one another in a row or stacked one above the other such that, in particular for each pair of shell-like containers, a first shell-like container, in which an energy storage cell is arranged, is inserted with its base surface into a second shell-like container, in which an energy storage cell is arranged.

In the method according to the invention for producing an energy storage apparatus, each energy storage cell, which has at least one electrode stack and/or electrode coil, is arranged in at least two shell-like containers, wherein each shell-like container has one base surface, one shell wall and an opening located opposite the base surface, wherein the shell-like containers are arranged next to one another in a row or stacked one above the other such that, in particular for each pair of shell-like containers, a first shell-like container, in which an energy storage cell is arranged, is inserted with its base surface into a second shell-like container, in which an energy storage cell is arranged.

The invention is based on the idea of providing shell-like containers instead of a closed housing for the individual energy storage cells, wherein one storage cell is located in each container. The container shells, each furnished with an energy storage cell are then placed, plugged or stacked into one another like stacked cups or stacked beakers. Thus, for each pair of container shells, a first furnished container shell, with its closed base side directed first through the open end of a second furnished container shell, is inserted into said second furnished container shell. Preferably, in doing so, the base side of the first container shell comes to lie on the energy storage cell located in the second container shell.

Compared to a stacking of energy storage cells accommodated in closed housings, in the case of the arranging in a row or stacking according to the invention of energy storage cells accommodated in shell-like containers, substantially less material is required for gas- and/or liquid-tight packing of the individual energy storage cells, because a container wall of the corresponding second container is replaced by the base side of the corresponding first container. The structure and also the production of the energy storage apparatus become substantially simpler as a result.

In a preferred configuration of the invention it is provided that each shell wall of the shell-like containers has a wall height with respect to the base surface, and the energy storage cell arranged in each shell-like container has a cell height with respect to the base surface which is smaller than the wall height. Hereby it is achieved that the shell walls of the first and second container shells overlap at least to some extent when the first container shell is inserted or plugged into the second container shell, wherein in particular the outer shell wall of the first container shell and the inner shell wall of the second container shell touch. As a result, both a mechanically stable and gas- and liquid-tight connection between first and second container shells can be achieved.

Preferably the wall height is approximately 1.5 to 2.5 times, in particular twice, as large as the cell height. In this way on the one hand a minimum overlap of the containers plugged into one another is ensured, by means of which a mechanically particularly stable connection between the container shells and also a particularly good gas and liquid tight fit of the energy storage cells accommodated in the container shells is achieved, and on the other hand the material requirement for the container shells is kept within limits.

In a preferred embodiment of the invention, the shell-like containers are realised in the manner of a set of stacked beakers, wherein the shell-like containers are substantially identical and configured with respect to shape and size such that they can be placed or plugged into one another. The appearance, in particular the shape, of the side walls of the shell-like containers is analogous to the shapes known in the case of stacked beakers or cups. For example, the side walls are constructed in a stepped manner such that each wall has a base-side section and an opening-side section adjoining said base-side section. Preferably, the width of a container in the region of the base-side section of the side wall is smaller than in the region of the opening-side section of the side wall. In particular, the outer side of the container in the region of the base-side section of the side wall is chosen such that this is approximately the same size as, or somewhat smaller than, the inner width of the container in the region of the opening-side section of the side wall, so that the base-side section of the side is wall of the first container fits into the opening-side section of the side wall of the second container. Alternatively or additionally, the side walls or individual sections of the side walls, particularly the opening-side sections of the side walls, do not run perpendicularly to the base surface. By means of one or a plurality of the previously mentioned measures, a reliable and sealed connection of the individual containers can be produced in a material-saving manner.

In a further preferred configuration, the respective shell wall of the shell-like containers is essentially realised in a planar manner. The structure can be realised particularly easily in this manner. It is additionally preferred that the respective shell wall or a side wall section of the respective shell wall of the shell-like containers is inclined with respect to the base surface by an angle which is larger than 90°. Hereby, the stackability of the shell-like containers is enabled in a particularly simple manner.

Preferably, the shell-like containers are electrically conductive, particularly in the region of the base surface. This can be achieved in that the containers are produced from an electrically-conductive material, e.g. a metal sheet.

It is further preferred that the outer base surface of the first container shell bears against the energy storage cell accommodated in the second container shell. As a result, a particularly compact arrangement of the containers arranged in a row next to one another or stacked on top of one another is achieved. For the case that the base surfaces of the containers are electrically conductive, a so-called bipolar arrangement of the electrode stack is achieved in this manner, in which the electrode stacks are connected in series so that the voltages generated in the individual electrode stacks add up for each such bipolar arrangement. The electrical connection of the energy storage cells therefore takes place via a very short path, namely the thickness of the respective base surface and also via the entire surface of the electrode stack. The current is collected via the containers located at the two opposite ends of the container stack. Compared to other battery designs, a substantially lower internal resistance, a lower weight and not least a smaller overall size result. For a bipolar energy storage apparatus is constructed in this manner, particularly a lithium-ion rechargeable battery, this means a markedly increased power density in addition to a flexible voltage choice.

In an equally preferred development of the invention, the shell walls of the first and second shell-like container are connected to one another. As a result, a stable, gas- and liquid-tight connection of the containers can be realised in a simple manner. Depending on the electrical wiring of the energy storage cells or the assembled containers, it may be required that an electrically insulating layer is introduced between the connected shell walls or shell walls to be connected.

Preferably, the shell wall of the second shell-like container in the region of the opening-side end of the shell wall is connected to the shell wall of the first shell-like container. In particular here, the shell walls of the first and second shell-like container are connected to one another by means of a gas- and/or liquid-tight seal, particularly a sealed seam. As a result, a reliable mechanical connection with good sealing is achieved in a simple manner.

In a further preferred configuration of the invention, at least one filling opening is provided in the shell wall of each shell-like container, through which electrolyte liquid can be filled into the shell-like containers. The filling opening is preferably located in the region of the energy storage cell arranged in the shell-like container. As a result, a subsequent—i.e. taking place after the stacking or an arrangement in a row next to one another of the containers—filling of the respective storage cell with electrolyte liquid is enabled, so that the assembly of the individual shell-like containers including the energy storage cells arranged therein can take place in a “dry” manner, wherein the electrolyte liquid does not have to be taken into account, which further simplifies the production of the energy storage apparatus as a whole.

In the method according to the invention, it is preferred that the shell walls of the first and second shell-like container are connected to one another, in particular by means of a gas- and/or liquid-tight seal, before a further shell-like container is added. The containers can as a result be connected to one another in a particularly simple and reliable manner with regards to assembly technology.

It is further preferred that the shell-like containers are only filled with the electrolyte liquid when a predetermined number of shell-like containers has been arranged in a row next to one another or stacked above one another and connected to one another, particularly when a predetermined overall length or overall height of the energy storage apparatus is reached. The individual shell-like containers including the energy storage cells arranged therein are therefore assembled in a “dry” manner, so that the assembly of the containers and/or the quality of the connection cannot be impaired by the presence of electrolyte liquid, which further simplifies the production of the energy storage apparatus and further increases its reliability.

Further advantages, features and application possibilities of the present invention result from the following description in connection with the figures. In the figures:

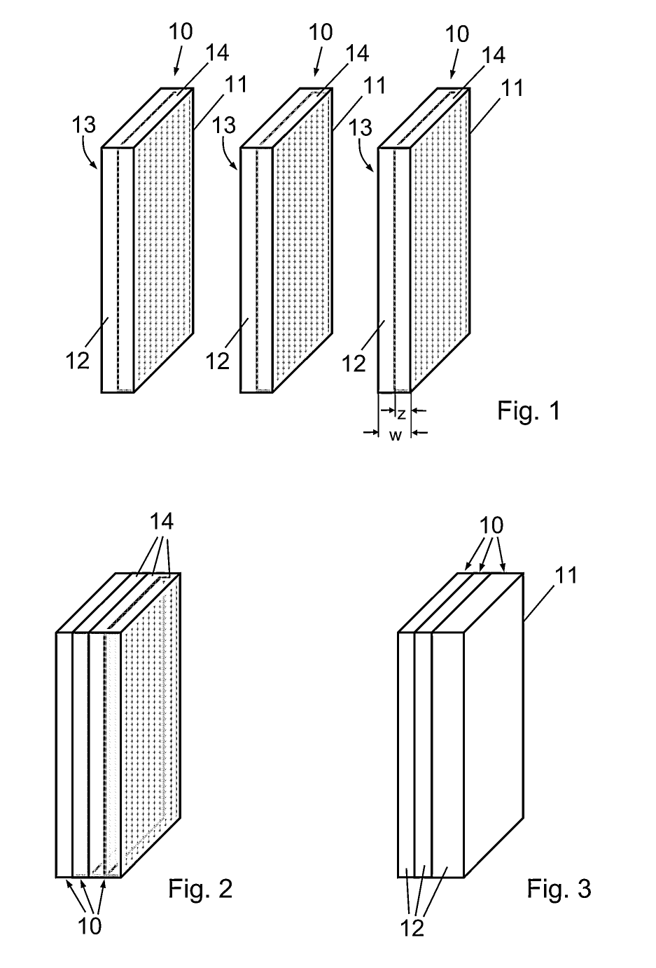

FIG. 1 shows a first example of shell-like containers in a perspective illustration;

FIG. 2 shows the containers showed in FIG. 1 in a stacked state in a perspective illustration;

FIG. 3 shows the containers shown stacked in FIG. 2 in another perspective illustration;

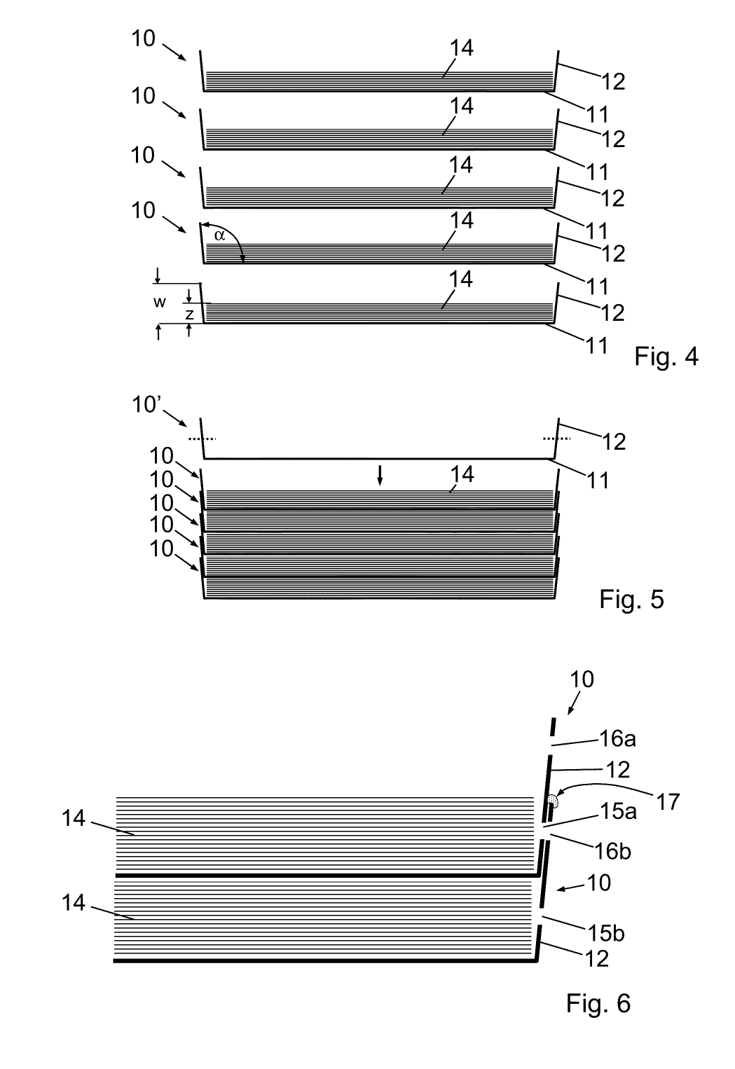

FIG. 4 shows a second example of shell-like containers in a cross-sectional illustration;

FIG. 5 shows the containers shown in FIG. 4 in a stacked state in a cross-sectional illustration;

FIG. 6 shows an enlarged section from the illustration shown in FIG. 5;

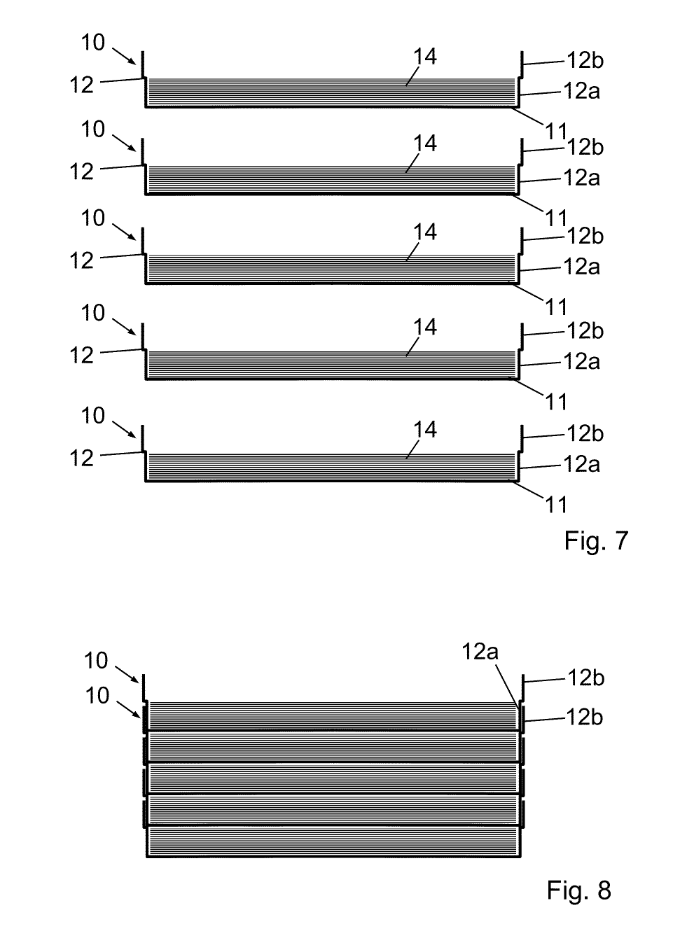

FIG. 7 shows a third example of shell-like containers in a cross-sectional illustration;

FIG. 8 shows the containers shown in FIG. 7 in a stacked state in a cross-sectional illustration;

FIG. 1 shows a first example of shell-like containers 10 in a perspective illustration. The containers 10 in each case have a rectangular, closed base surface 11, which is adjoined by a planar side wall 12 running essentially perpendicularly to the base surface 11. The height of the side wall 12 is considerably smaller than the side lengths of the base surface 11, furthermore the region 13 opposite the base surfaces 11 is open. The containers 10 consequently have the shape of a shell which is open on one side, in each of which an energy storage cell 14 can be accommodated in the form of an electrode stack or electrode coil.

The electrode stack for the most part preferably has a plurality of electrode groups, each group being composed of two electrodes and also a separator layer, which may accommodate an electrolyte, located therebetween, which electrode groups are arranged or stacked next to one another or above one another. In the case of an electrode coil, at least one electrode group is wound to form a so-called coil.

In the example illustrated, each energy storage cell 14 on the inside of the base surface 11 of its respective shell-like container 10 bears against or on said base surface (11). In the perspective view chosen here, the base surfaces 11 and also the side walls 12 are illustrated in a transparent manner, so that the energy storage cells 14, which are located in the interior of the shell-like containers 10, only indicated schematically, can be seen.

In the present example, the cell height z above the base surface 11 of the energy storage cell 14 bearing against the base surface 11 is approximately half of the wall height w of the side wall 12. As a result there remains a free space between the energy storage cell 14 located in a container 10 and the upper end of the side wall 12 surrounding the energy storage cell 14, in which free space a further shell-like container 10—either with an energy storage cell 14 located therein, or else, if appropriate, without—can be accommodated. In this manner, two or a plurality of containers 10 can be arranged in a row next to one another or stacked above one another. This is explained in more detail in the following.

FIG. 2 shows the container 10 illustrated in FIG. 1 in the stacked state, which was achieved in that the centre container 10 shown in FIG. 1 together with the energy storage cell 14 located therein was placed and/or plugged into the container 10 located to its right, in that the centre container 10 was inserted by means of its base surface 11 through the open region 13 of the right container 10 and into the same until the base surface 11 of the centre container 10 lies on the surface of the energy storage cell 14 in the right container 10. Accordingly, the container 10 located on the left in FIG. 1 together with the energy storage cell 14 located therein is inserted or plugged into the centre container 10.

The individual energy storage cells 14 are therefore located as closely as possible to one another and each one is only separated from the next by means of a base surface 11, which is illustrated with the aid of the transparent illustration of the container 10 including energy storage cells 14 chosen in FIG. 2.

FIG. 3 shows the stacked containers 10 illustrated in FIG. 2 in a perspective illustration, in which the base surface 11 and also the side surfaces 12 of the container are not illustrated transparently. As is illustrated on the basis of this illustration, the respective side walls 12 of the containers 10 project approximately halfway out of the respective container 10 into which they have been plugged or placed. Only the side walls 12 of the container 10 located furthest to the right in this example can be seen completely in this illustration.

In the case of the arrangement in a row or stacking of the shell-like containers 10 and the energy storage cells 14 located therein, substantially less material is required compared to a stacking of energy storage cells accommodated in closed housings in order to achieve a gas- and/or liquid-tight packing of the individual energy storage cells 14, since in the case of the arrangement described, one wall of each housing of the energy storage cell 14 located in a shell-like container 10, is formed by the base surface 11 of the next container inserted into the first container. The structure and the production of the energy storage apparatus according to the invention is considerably simplified as a result.

FIG. 4 shows a second example of shell-like containers 10 in a cross-sectional illustration. The containers 10 have a preferably rectangular base surface 11, wherein a shell wall 12 is arranged at the edge of each rectangular base surface 11. In the present example, the shell walls 12 enclose an angle α with each base surface 11, which is larger than 90° and in particular lies between 92° and 98°. As a result, the stackability of the containers 10 is realised in a particularly simple manner.

Preferably, the shell-like containers 10 are constructed in one piece, i.e. the base surface 11 and the side walls 12 adjoining the same are formed from just one workpiece, for example by means of deep drawing a sheet metal blank.

In the interior of each shell-like container 10, there is an energy storage cell 14 in the form of an electrode stack or electrode coil. The cell height z of the respective energy storage cell 14 also corresponds in this example to approximately half the wall height w of the side walls 12 above the base surface 11. Fundamentally, it may be of advantage, depending on the field of application, to provide larger or smaller wall heights w. In order to achieve a good mechanical connection of the containers 10 with not too large a material requirement, it is preferred that the wall height is approximately between 1.5 times and 2.5 times the cell height z.

FIG. 5 shows the shell-like containers 10 illustrated in FIG. 4 in the stacked state, wherein for each pair of shell-like containers 10, one upper container 10 is inserted, particularly placed or plugged, by means of its base surface 11 into the respectively below-located container 10, in which an energy storage cell 14 is accommodated, until the base surface 11 of the upper container 10 comes to lie on the upper surface of the energy storage cell 14 located in the lower container 10 and/or until the placing or plugging of the upper container 10 into the lower container 10 is stopped due to a frictional connection and/or positive-locking connection between the side walls 12 of the upper container 10 and the side walls 12 of the lower container 10.

In order to also encapsulate in a gas- and/or liquid-tight manner the energy storage cell 14 located in the uppermost container 10 of the container stack obtained in this manner, a further shell-like container 10′, in which no energy storage cell is located, can be placed or plugged into the uppermost container 10 of the container stack, which is indicated in FIG. 5 by means of a vertically downwardly directed arrow. This further container 10′ is subsequently also called sealing container.

The side walls 12 of the sealing container 10′ can in this case be constructed lower than the side walls 12 of the remaining containers 10 of the stack. Preferably it is sufficient here to choose for the side walls 12 of the sealing container 10′ to be so high that the same terminate approximately flush with the upper edge of the side walls 12 of the uppermost container of the stack following the placing or plugging into the uppermost container 10 of the stack. This height is indicated in the example illustrated here on the basis of dashed lines on the sealing container 10′.

FIG. 6 shows an enlarged section from the two lowermost containers 10 from the illustration shown in FIG. 5. Each of the containers 10 has a first opening 15a or 15b and also a second opening 16a or 16b located above the first opening 15a or 15b in the region of a side wall 12. The two openings 15a and 15b and 16a and 16b are here arranged such that the first opening 15a of the upper container 10 inserted into the lower container 10 comes to lie in the region of the second opening 16b of the corresponding lower container 10, when the upper container 10 has been inserted or plugged into the lower container 10 in the manner according to the invention. Each of the first openings 15a and 15b are preferably arranged on the side walls 12 such that the same lie in the region of the height of the corresponding accommodated energy storage cell 14.

By means of the previously described arrangement of the first and second openings 15a and 15b or 16a and 16b in the containers 10, it is achieved that the containers 10 can only be filled with electrolyte liquid subsequently, i.e. following the assembly according to the invention to form a stack. This has the advantage in terms of assembly technology that during the stacking of the containers 10, each furnished with an energy storage cell 14, no intermediate steps, in which electrolyte liquid is introduced into the respective container 10, are required. Further, during the assembly of the individual containers 10 one does not have to take into consideration the possibility of leaking electrolyte liquid, so that the assembly of the individual containers 10 can take place both in the horizontal and in the vertical or tilted position of the respective containers 10.

Preferably, the stacked containers 10 are only filled with the electrolyte liquid when a predetermined stack size has been reached, i.e. when a predetermined number of shell-like containers 10 has been arranged in a row next to one another or stacked on top of one another and preferably also connected to one another.

The first or second openings 15a and 15b or 16a and 16b are sealed in a gas- and/or liquid-tight manner with suitable sealing means after filling the containers 10 with electrolyte liquid. This can, for example, take place by means of suitable prefabricated plugs. Alternatively or additionally, it is also possible to provide one thread overlapping each pair of first and second openings 15a and 16b, into which thread a screw can be screwed. Preferably a thread is provided only in the first openings 15a and 15b and a simple hole is provided in the second openings 16a and 16b through which a screw can be screwed into each thread of the first opening 15a located below the said second opening. In addition to the desired sealing function, a screw of this type additionally fulfils the function of a reliable and simple mechanical connection of the two containers 10. Of course, the first opening 15b of the lowermost container 10 of the stack can be sealed by means of a screw of this type. Preferably a seal ring, for example made of rubber or plastic, can additionally be provided on the respective screw head, which contributes to a particularly reliable gas- and/or liquid-tight seal either of the first and second openings 15a and 16b lying above one another or of the first opening 15b.

Alternatively or additionally, the openings 15a and 15b or 16a and 16b can however also be sealed with a suitable sealing compound. In this case, sealing compound is applied onto the opening 15a and 15b or 16a and 16b after the filling of the respective container and/or introduced into the same at least to some extent. The sealing compound is here preferably supplied such that said compound cures itself at room temperature. Alternatively or additionally it is also possible to use sealing compounds which for example only cure during or following heating or irradiation with heat radiation or ultraviolet radiation.

The containers 10 placed or plugged into one another are preferably connected to one another in the region of the respective side walls 12. Alternatively or additionally to the previously described possibility of using screws, a connection between the containers 10 placed or plugged into one another is preferably realised by means of a seal 17, which is provided in the region of the upper edge of the corresponding lower container 10 and produces a gas- and/or liquid-tight connection to the side wall 12 of the upper container 10 plugged into the lower container 10. Preferably, the seal 17 runs along the entire upper edge of the side wall 12 of the lower container 10 around the entire side wall 12 of the upper container 10. Preferably, a container 10 added in the manner according to the invention is connected by means of a corresponding sealing seam to its corresponding lower container 10 before a further container 10 is added.

FIG. 7 shows a third example of shell-like containers 10 in a cross-sectional illustration. In this example, the side walls 12 of the containers 10 are configured in a stepped manner, wherein said side walls 12 each have a base-side side wall section 12a and also a second side wall section 12b, which is outwardly offset in a stepped manner, adjoining the same. The width of the respective container 10 is as a result smaller in the region of the base-side wall section 12a of the side wall 12 than in the region of the opening-side side wall section 12b of the side wall 12. Also in this variant, a reliable stacking of the containers 10 is enabled in a simple manner.

Preferably, the two side wall sections 12a and 12b are configured such that the outer width of the container 10 in the region of the base-side side wall section 12a is approximately the same size or somewhat smaller than the inner width of the container 10 in the region of the opening-side side wall section 12b. As a result, the base-side side wall section 12a of the side wall 12 of an upper container 10 can be inserted into the opening-side side wall section 12b of the side wall 12 of a container 10 located beneath the same. If appropriate, the first and/or second side wall section 12a or 12b can additionally be orientated such that the same are inclined by an angle with respect to the respective base surface 11 which is larger than 90°. As can be seen in FIG. 7, the height of the base-side side wall section 12a preferably corresponds approximately to the height of the energy storage cell 14 bearing on the base surface 11 of the container 10.

FIG. 8 shows the containers 10, illustrated in FIG. 7, in the stacked state in a cross-sectional illustration. Analogously to the example shown in FIG. 5, the shell-like containers 10 are placed or plugged into one another such that the respective surfaces 11 in each case come to lie on the upper side of the energy storage cell 14 located in a lower container 10 and contact said energy storage cell. A corresponding upper container 10 is placed or plugged, with its base surface 11 entering first, into a container 10 located below it, wherein the lower side wall section 12a of the corresponding upper container 10 slides along on the upper side wall section 12b of the corresponding lower container 10 until the base surface 11 of the corresponding upper container 10 has reached the height of the respective step-like transition between the base-side and opening-side side wall section 12a or 12b of the lower container 10.

In this example also, openings (not illustrated) are provided in the region of the side walls 12 of the containers 10, by means of which the containers 10 can be filled with electrolyte liquid. Furthermore, the individual containers 10 are likewise preferably connected to one another by means of a seal. The statements relating to this in connection with the examples shown in the FIGS. 4 to 6 apply here accordingly.

1. An energy storage apparatus comprising:
two or a plurality of energy storage cells, each with at least one electrode stack and/or electrode coil; and
two or a plurality of shell-like containers, each with one base surface, one shell wall and an opening located opposite the base surface,
wherein one energy storage cell is arranged in each of the shell-like containers, and
wherein the shell-like containers are arranged next to one another in a row or stacked one above the other such that a first shell-like container, in which an energy storage cell is arranged, is inserted with its base surface (11) into a second shell-like container, in which an energy storage cell is arranged.

2. The energy storage apparatus according to claim 1, wherein the respective shell wall of the shell-like containers has a wall height with respect to the base surface and the energy storage cell respectively arranged in the shell-like containers has a cell height with respect to the base surface which is smaller than the wall height.

3. The energy storage apparatus according to claim 2, wherein the wall height is approximately 1.5 to 2.5 times, in particular twice, as large as the cell height.

4. The energy storage apparatus according to claim 1, wherein the shell-like containers are realised in the manner of a set of stacked beakers, wherein the shell-like containers are identical with respect to shape and size and can be placed or plugged into one another.

5. The energy storage apparatus according to claim 1, wherein the shell walls of the shell-like containers each have a base-side side wall section and an opening-side side wall section which adjoins the base-side side wall section and is offset to said opening-side side wall section in a stepped manner.

6. The energy storage apparatus according to claim 5, wherein the width of the shell-like containers in the region of the base-side side wall section is smaller than in the region of the opening-side side wall section.

7. The energy storage apparatus according to claim 1, wherein the respective shell wall of the shell-like containers is essentially realised in a planar manner.

8. The energy storage apparatus according to claim 1, wherein each shell wall or the opening-side side wall section of the shell-like containers is inclined with respect to the base surface by an angle which is larger than 90°.

9. The energy storage apparatus according to claim 1, wherein the shell walls of the first and second shell-like container are connected to one another.

10. The energy storage apparatus according to claim 1, wherein the shell wall of the second shell-like container is connected in the region of the opening-side end of the shell wall to the shell wall of the first shell-like container.

11. The energy storage apparatus according to claim 9, wherein the shell walls of the first and second shell-like container are connected to one another by means of a gas- and/or liquid-tight seal, particularly a sealed seam.

12. The energy storage apparatus according to claim 1, wherein at least one filling opening is provided in each shell wall of the shell-like containers, through which electrolyte liquid can be filled in the shell-like containers.

13. The energy storage apparatus according to claim 12, wherein the filling opening is located in the region of the energy storage cell arranged in the shell-like container.

14. The energy storage apparatus according to claim 12, wherein a first filling opening and a second filling opening are each provided in the shell wall of the shell-like containers, wherein the two filling openings are arranged such that the first filling opening of the first container inserted into the second container comes to lie in the region of the second opening of the second container.

15. A method, comprising:
producing an energy storage apparatus, in which one energy storage cell, which has at least one electrode stack and/or electrode coil, is arranged in at least two shell-like containers, which each has one base surface, one shell wall and an opening located opposite the base surface, wherein the shell-like containers are arranged next to one another in a row or stacked one above the other such that a first shell-like container, in which an energy storage cell is arranged, is inserted with its base surface thereof into a second shell-like container, in which an energy storage cell is arranged.

16. The method according to claim 15, wherein the shell walls of the first and second shell-like container are connected to one another, in particular by means of a gas- and/or liquid-tight seal, before a further shell-like container is added.

17. The method according to claim 15, wherein the stacked containers are filled with the electrolyte liquid only when a predetermined number of shell-like containers has been arranged in a row next to one another or stacked on top of one another and also connected to one another.
